(19) United States
(12) Patent Application Publication
(10) Pub. No.: US 2005/0128661 A1
(43) Pub. Date: Jun. 16, 2005

(54) Method and device for protecting a conductor when an electric arc is produced

(76) Inventors: Rainer Maeckel, Koenigswinter (DE); Harry Popp, Nuernberg (DE); Thomas Schulz, Unterensingen (DE); Eike Thull, Roth (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/483,381

(22) PCT Filed: Jun. 22, 2002
(86) PCT No.: PCT/EP02/06917

(30) Foreign Application Priority Data
Jul. 10, 2001 (DE) 101 32 752.8

(51) Int. Cl. H02H 3/00

(52) U.S. Cl. 361/42

(57) ABSTRACT

In order to recognize an electric arc in a 42V vehicle electrical system and initiate suitable protective measures, a detection line is at least partially guided along a current conducting supply line for the protection thereof, whereby the current flow (I_{V}) in the supply line is at least reduced by means of a detection flow (I_{D}) flowing along the detection line when an electric arc occurs.

### BACKGROUND AND SUMMARY OF THE INVENTION

The invention relates to a method for protecting a conductor when an electric arc occurs, in particular for protection of a 42V vehicle power supply system conductor in a motor vehicle. It also relates to an apparatus for carrying out the method.

As a result of the increase in the vehicle power supply system voltage in motor vehicles from the previously normal 12V to 42V now, there is a risk of electric arcs being formed as a consequence of contact between a line which is carrying a correspondingly high potential and either a further line which is carrying a comparatively low potential or the vehicle bodywork, which is normally at ground potential. If an electric arc is formed, then its high temperature furthermore results in the risk of a stable operating point being formed for the electric arc, wherein the arc thus burns continuously. This may result in considerable damage in the vehicle.

Since electric arcs can occur only above an operating voltage of about 16V, because the present-day vehicle power supply system voltage is only 12V, no specific measures have been provided until now for protection against electric arcs in a motor vehicle power supply system. In fact, only fuse links are used at the moment in order to interrupt live supply lines in the event of a short circuit in a motor vehicle, and their tripping times are defined by the so-called melting integral (I²·t).

The use of fuse links in a motor vehicle with an operating voltage above 16V, in particular greater than or equal to 36V, does not, however, offer sufficient protection for a situation in which contact between a 36V line or 42V line and ground does not result in a “hard” short-circuit as a result of a direct contact, but rather the formation of an electric arc—even if this is intermittent. As a consequence of the electric are formation, the current is considerably less than the short-circuit current without an arc, and is thus considerably reduced.

For example, in the case of an operating voltage of 36V and a vehicle battery having an internal resistance of 30 mΩ, and with an additional resistance in the short-circuit path of 1 mΩ, the resultant short-circuit current is 1160A. This short-circuit current is more than five times the rated current of a conventional 200A fuse link, so that this makes it possible to ensure that the fuse link will blow quickly. When, in contrast, an arc occurs in the region of the short-circuit point, then a voltage of, for example, 26V is dropped across this arc. This results in the voltage across the short-circuit being reduced to 10V, and the short-circuit current being reduced to approximately 320A. However, since a fuse link does not blow until a current of 270A at the earliest, a short-circuit current such as this means that it cannot be assumed that the fuse will blow quickly. In fact, in this case, it can be expected that it will take several minutes for the fuse to blow, during which period, however, the arc can result in considerable damage to the vehicle.

U.S. Pat. No. 5,541,803 discloses an electrical safety device which can be used to detect an overtemperature or mechanical damage. This is done by the use of a sensor conductor with an uninterrupted loop. The sensor wire is arranged between a part (which is supplied with power) of an electrical component to be monitored and the outer surface of the components, for example a supply line. Furthermore, a reference conductor is provided and is used to detect the ambient temperature, by using resistance differences between this reference conductor and the sensor conductor to detect any overtemperature. The sensor conductor and the reference conductor are also embedded in the insulation of the supply line to be monitored, in which case the sensor conductor may also have its own insulation, although this is not the same as the insulation of the supply line to be monitored.

EP-A-0 617 498 also discloses a safety device for protection of cables and devices against faults caused by fire. Electrical arcs caused, for example, by wear, and conductivity resulting from it, can lead to permanent carbonization of the insulation and, following this, to ignition of the insulation. In order to prevent this, a monitoring wire is wound around the conductor. This monitoring wire is used as an electrical heat sink in order to reduce the temperature and is connected to a current limiting circuit, which acts provided that the amount of heat which is developed is not yet excessive. The monitoring wire has a flexible insulating coating which is in turn surrounded by the insulation of the conductor to be monitored.

The invention is based on the object of specifying a method by which an arc is identified and countermeasures are initiated. A further aim is to specify an apparatus which is particularly suitable for carrying out the method for protection of a conductor when an arc occurs, in particular for protection of a 42V vehicle power supply system conductor in a motor vehicle.

With regard to the method, the stated object is achieved according to the invention. The invention provides for a sensor line to be routed along at least part of a live supply line. A detection current, which flows via the sensor line as a consequence of an arc, is then used preferably to interrupt the current flow via the supply line, or at least to reduce it, in that an insulation material which surrounds the detection line becomes thinly viscous at a defined melting temperature at the point at which the arc occurs, and flows away, so that a reliable coupling is quickly formed between the detection line and the supply line.

The invention is in this case based on the idea that an arc can be identified when a coupling to a further line can be formed at the relevant point as a consequence of the arc, which coupling can be used only for arc detection but not for carrying the normal operating current of a load which is connected to the relevant supply line. A coupling such as this to an additional detection line then occurs either to the potential of the arc voltage, to the potential of the supply line, or to ground.

The coupling can in turn be produced by using the locally greatly increased temperature of the appropriate point that is known to occur in the event of an arc, in order to melt insulation which is located between the detection line and the supply line, which is normally part of a cable. This insulation will then melt as a consequence of the high temperature at this point when an arc occurs, and will in practice be split open locally. This will result in a reliable contact, in particular between the supply line and the detection line, with the consequence that a current flow is produced in the detection line, and this can be identified as the occurrence of an arc.

The corresponding detection current itself, or a voltage which is produced as a consequence of it, is then advantageously used in order to initiate the protection measure. At least a reduction in the current in the supply line is envisaged as a protection measure. Expediently, however, the connection of the supply line to the current source, and thus the current flow which is passed through it, are interrupted by means of a switch which is preferably arranged in the supply line itself and is driven directly by the detection current or indirectly via the voltage which is preferably measured on the detection line. This may be achieved by using a pyrotechnic isolating switch which is triggered by a detection current, or an electromechanical switch, for example a relay, or a semiconductor switch.

With regard to the apparatus, the stated object is achieved according to the invention by having at least one detection line, at least part of which is arranged along a supply line which can be connected to a current source, and having a protection device, which is connected in the connection between the current source and the supply line and is driven by a detection current. The detection current flows via the detection line as a consequence of an arc and drives the protection device in order to reduce the current flow via the supply line. The detection line is surrounded by insulation material, which is thinly viscous at a defined melting temperature, and can flow away. Advantageous refinements and developments are the subject matter of the dependent claims.

The sensing or detection line which is provided for identification and thus for detection of an arc expediently itself has insulation and may, for example, be twisted as an insulated braided cable harness into the cable which contains the supply line. In this case, the detection or additional line may be twisted with the supply cable as an internal or external braided cable harness. In this case, the detection line is arranged within the supply cable and is expediently arranged spirally along the supply line, so that the detection line surrounds the supply line at least in places so that, in practice, an arc can be identified over the entire circumference of all sides of the supply line.

If the twist spiral has a relatively long lay length, the expediently insulated additional or detection line may also be twisted into place retrospectively. In this case, it is expedient to reduce the pitch of the spiral by means of a short lay length. The additional detection line may also be in the form of a single, varnished copper wire. This can then be incorporated into the insulation of the supply cable during an extrusion step. As a consequence, the complexity is considerably less than that of a screened cable, owing to the lack of insulation. An individual detection line or two or more detection lines, may also be arranged or fastened externally on the cable insulation.

The insulation material of the additional detection line need not be the same as the insulation material of the supply line to be protected. An insulation material, for example PP, with a defined melting point in the range between preferably 130° C. and 180° C., is advantageously used for the additional detection line. The insulation material should in this case not be viscofluid, but should be capable of flowing away as well as possible in order to make it possible to ensure a reliable coupling and contact. The supply line may also be in the form of a flat conductor or ribbon conductor. When using film technology such as this, in which the live flat conductor is embedded as a supply conductor in insulating film, the flat conductor, which acts as the supply conductor, is at least partially surrounded by the sensing or detection line. This may likewise be a thin sheet or else a varnished copper wire. Two such detection lines may also run in the ribbon conductor, arranged at a distance from the actual supply line. A single detection line may entirely surround the supply line or else may be arranged only on one side along it.

### BRIEF DESCRIPTION OF THE DRAWINGS

Exemplary embodiments of the invention will be explained in more detail in the following text with reference to a drawing in which, in each case illustrated in a highly simplified form:

FIG. 1 shows a detail of a motor vehicle power supply system, illustrated in the form of a block diagram, with a circuit breaker which is connected directly to a detection line,

FIG. 2 shows in an illustration corresponding to FIG. 1, a circuit breaker which is connected to the detection line via a voltage meter,

FIGS. 3a to 3d show section illustrations of various embodiments of a detection line which is incorporated in or fitted to a supply cable, and

FIG. 4 shows a supply line which is in the form of a ribbon conductor with an adjacent detection line.

### DETAILED DESCRIPTION OF THE DRAWINGS

Mutually corresponding parts are provided with the same reference symbols in all of the figures.

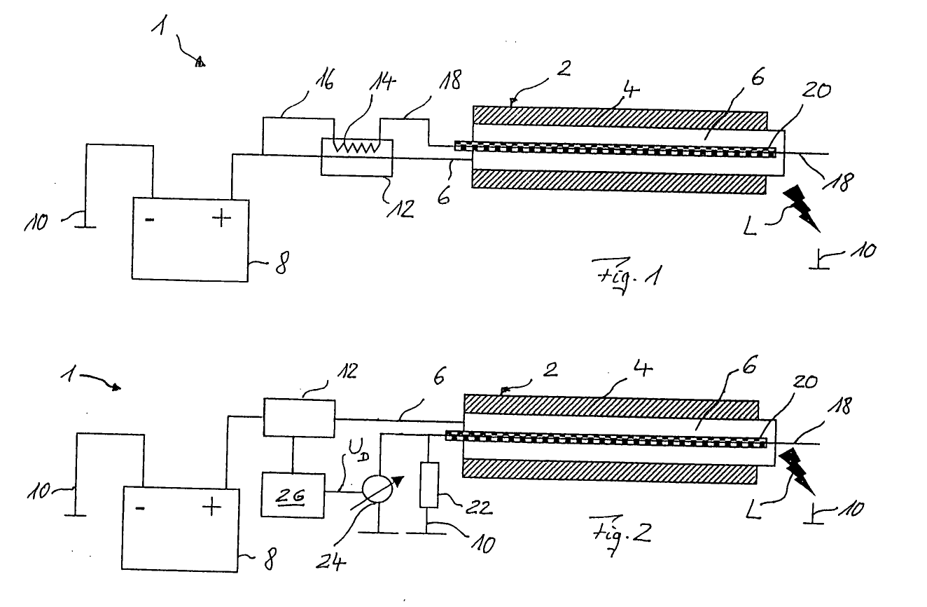

As is shown in FIGS. 1 and 2, a vehicle power supply system cable 2 in a motor vehicle power supply system 1 has a supply line 6 which is surrounded by insulation 4 and which is connected to a current source in the form of a battery 8, in order to form a main circuit. The main circuit is in this case closed via the supply line 6, which is connected to the positive pole (+) of the battery 8, and ground 10, to which the negative pole (−) of the battery 8 is connected. The cable network, part of which is illustrated, is, in particular, part of a 42V vehicle power supply system for a motor vehicle. A vehicle power supply system such as this is normally constructed hierarchically and the power is distributed between various loads, for example a turn indicator relay or a headlight with a dimming facility.

A circuit breaker 12 is provided in a supply line 6 between the battery 8 and a line or cable section (which is under consideration here and is illustrated in an enlarged form) of the supply line 6. The supply line 6 leads to a load (which is not illustrated) and via this to ground 10. In the exemplary embodiment, the circuit breaker 12 is a pyrotechnic isolating switch 12, which is connected in the supply line 6 and has an initiator 14 which is connected via a connection 16 on the one hand to the positive pole (+) of the battery 8 and on the other hand to a sensing or detection line 18. Instead of being connected to the positive pole (+) of the battery 8, the connection 16 may also be connected, in a manner which is not illustrated in any more detail, to a comparable terminal connection in a controller in the motor vehicle.

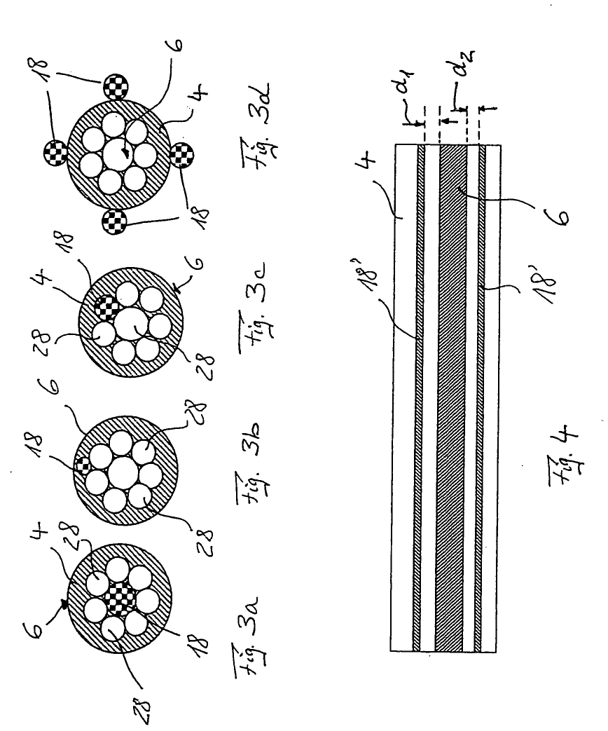

The detection line 18 is surrounded by insulation 20, which is preferably composed of a material with a defined melting point in the range between 130° C. and 180° C. The detection (or sensor line) 18 is routed along the supply line 6, at least in places. The arrangement of the detection line 18 with its insulation 20 in or on a supply cable with a braided, preferably twisted, supply line 6 is illustrated in FIG. 3, while FIG. 4 shows an embodiment of the supply cable 6 with an integrated detection line 18 using film technology. The detection line 18 preferably surrounds the supply line 6 on all sides, at least in places.

In the embodiment shown in FIG. 2, the detection line 18 is connected to ground 10 via a pull-down resistor 22. The resistor 22 is connected in parallel with a voltage meter 24, whose measurement signal, which is derived from the measured voltage UD, is supplied to a tripping or drive apparatus 26. The initiator 14 of the isolating switch 12 may, in turn, be connected to the tripping apparatus 26. In this embodiment as shown in FIG. 2, however, a semiconductor switch or an electromagnetic switch 12, for example a relay, is shown instead of the pyrotechnic isolating switch. In order to operate this by the use of a control signal S which is produced by the tripping or drive apparatus 26, it is then in turn connected to the detection line 18 directly on the drive side as shown in FIG. 1, or indirectly via the voltage measurement devices 22 to 26, as shown in FIG. 2.

In the cable embodiments shown in FIGS. 3a to 3c, the detection line 18 is twisted with individual cores or conductors 28 of the supply line 6. Independently of any twisting or the degree of twisting, the individual conductors 28 of the detection line may be incorporated into the cable or conductor insulation 4 of the supply line 6, running centrally or off-center, depending on the supply cable which is used and depending on the best way of manufacture or production, respectively. The supply line 6, which comprises the individual conductors 28, together with the insulation 4 which surrounds or encloses it, will be referred to in the following text as the supply cable.

In this case, the detection line 18 may itself once again be twisted as an insulated additional line 18, with its insulation 20, as an insulated braided cable harness into the supply cable 6, in which case an internal arrangement as shown in FIG. 3a or else an external arrangement as shown in FIG. 3b may be advantageous with regard to the detection sensitivity and/or production-engineering aspects. The insulated detection line 18 may also be integrated in the supply line 6 in such a way that, within the conductor or core assembly, it assumes the position of an individual core 28 of the supply line 6. The essential feature in this case is that the detection line 18, including its insulation 20, is arranged as close as possible to at least one individual single core 28 of the supply line 6, with the aim of arranging the detection line 18 as far as possible over the entire length of the supply line 6 and/or in length sections which are, as far as possible, indefinitely short, and/or at the same time on as many sides of the supply cable as possible.

FIG. 3d shows an alternative embodiment where four detection lines are arranged so as to be distributed uniformly around the circumference of the cable insulation 4 of the supply cable. Instead of the four detection lines 18 illustrated in the exemplary embodiment, it is also possible to arrange a greater or lesser number of detection lines 18 distributed around the circumference of the supply cable 4, which carries the supply line 6.

In the ribbon embodiment that is illustrated in FIG. 4, the supply line 6 is in the form of a flat conductor, which is arranged in an insulating film 4′. The detection line 18′ also runs within this insulating film 4′. In this case, the detection line 18′ may likewise be a flat conductor in the form of a thin flat or ribbon conductor, or else may be in the form of a varnished copper wire. Furthermore, a detection line 18′ (or two or more detection lines 18′) may be arranged on each of the two sides of the supply line 6, which is in the form of a flat conductor. In this case, the distances d₁ and d₂ from the supply line 6 may be the same or may differ. Furthermore, the supply line 6 may be entirely or partially surrounded by each of the two detection lines 18′. In addition, the (or each) detection line 18′ may completely surround the supply line 6, which acts as the main conductor, or else may be arranged only along one side of it.

In the situation where an arc L occurs as a consequence of a line defect on the supply line 6, a greatly increased temperature occurs at the corresponding point. As a consequence of this, the insulation 20 on the detection line 18 splits open, and a coupling is produced at the relevant melting point either to the potential of the arc voltage or to the potential of the supply line 18, or to ground 10. This is identified by the detection line 18 through which this contact via the arc L results in a detection current ID flowing. This is used to drive the switch 12 or to activate the initiator 14, and in consequence to trip the isolating switch 12, so that the supply line 6, and thus the current flow of the main or supply current Iv flowing through it, are interrupted. If an electronic semiconductor switch is used, it is also possible just to reduce the current Iv flowing via the supply line 6, which results in the arc L being quenched.

In the embodiment that is illustrated in FIG. 2, the arc L is identified via a voltage measurement. In this case, the voltage UD on the detection or sensing line 18 is determined, and a corresponding tripping signal S is transmitted to the switch 12 via the tripping device 26 in order to operate it, that is to say to open it. Since, normally, that is to say when the vehicle power supply system and hence the supply line 6 are being operated correctly, without any faults, there is no potential on the detection line 18, which is kept at ground potential via the pull-down resistor 22, any connection or coupling in the event of an arc L and any current flow ID associated with this via the resistor 22 is detected by means of the voltage meter 24 and, consequently, the switch 12 is opened. If an electronic semiconductor switch 12 is used, this is actuated appropriately, for example only in order to reduce the current Iv flowing via the supply line 6, completely, or to maintain a minimum current Iᵥ via the supply line 6.

1-14. (canceled)

15. A method for protecting a conductor when an electric arc occurs in a 42V vehicle power supply system conductor in a motor vehicle, wherein a supply current is passed from a current source via at least one supply line along at least part of which a detection line is passed, and further wherein a current flow via the supply line is at least reduced by use of a detection current which flows via the detection line as a result of an electric arc, wherein an insulation material, which surrounds the detection line becomes thinly viscous at a defined melting temperature at the point of which the electric arc occurs, and flows away, so that a reliable coupling is quickly formed between the detection line and the supply line.

16. The method as claimed in claim 15, wherein the detection current is used to interrupt the supply current.

17. The method as claimed in claim 15, wherein the detection current is transmitted to a circuit breaker, which is located in the supply line, in order to operate it.

18. The method as claimed in claim 16, wherein the detection current is transmitted to a circuit breaker, which is located in the supply line, in order to operate it.

19. The method as claimed in claim 15, wherein the detection current is detected by a voltage (UD) which is produced by it, and a switch, which is located in the supply line, is opened by a signal derived from said voltage.

20. The method as claimed in claim 16, wherein the detection current is detected by a voltage (UD) which is produced by it, and a switch, which is located in the supply line, is opened by a signal derived from said voltage.

21. The method as claimed in claim 17, wherein the detection current is detected by a voltage (UD) which is produced by it, and a switch, which is located in the supply line, is opened by a signal derived from said voltage.

22. An apparatus for protecting a conductor when an arc occurs in a 42V vehicle power supply system in a motor vehicle, comprising:
at least one detection line, at least part of which is arranged along a supply line which is connectable to a current source, and
a protection device, which is connected in a connection between the current source and the supply line and is driven by a detection current, which flows via the detection line as a consequence of an electric arc, in order to reduce current flow via the supply line,
wherein the detection line is surrounded by insulation material which is thinly viscous at a defined melting temperature, and can flow away.

23. The apparatus as claimed in claim 22, wherein the defined melting temperature of the insulating material is between 130° C. and 180° C.

24. The apparatus as claimed in claim 22, wherein the detection line surrounds the supply line on all sides, at least in places.

25. The apparatus as claimed in claim 23, wherein the detection line surrounds the supply line on all sides, at least in places.

26. The apparatus as claimed in claim 22, wherein the detection line is twisted with the supply line.

27. The apparatus as claimed in claim 23, wherein the detection line is twisted with the supply line.

28. The apparatus as claimed in claim 24, wherein the detection line is twisted with the supply line.

29. The apparatus as claimed in claim 22, wherein the detection line is arranged within cable insulation on the supply line.

30. The apparatus as claimed in claim 23, wherein the detection line is arranged within cable insulation on the supply line.

31. The apparatus as claimed in claim 24, wherein the detection line is arranged within cable insulation on the supply line.

32. The apparatus as claimed in claim 26, wherein the detection line is arranged within cable insulation on the supply line.

33. The apparatus as claimed in claim 22, wherein the protection device is one of a pyrotechnic, an electromechanical, and an electronic isolating switch.

34. The apparatus as claimed in claim 22, wherein the supply line is in the form of a flat conductor, and the detection line is arranged such that it runs adjacent to the supply line.

35. The apparatus as claimed in claim 34, wherein the supply line, which is in the form of the flat conductor, and the detection line, are arranged within the same sheet insulation.

36. The apparatus as claimed in claim 34, wherein a detection line is arranged on each of the two sides of the supply line which is in the form of the flat conductor.

37. The apparatus as claimed in claim 35, wherein a detection line is arranged on each of the two sides of the supply line which is in the form of the flat conductor.

38. A method for protecting a supply line when an electric arc occurs in a 42V vehicle electrical system, the method comprising the acts of:
passing a supply current from a current source via the supply line;
when the electric arc occurs, melting and flowing away at a defined melting temperature an insulation material surrounding a detection line that is at least partially guided along the supply line so that a reliable coupling is quickly formed between the detection line and the supply line causing a detection current to flow; and
reducing the supply current based on the detection current.

39. The method according to claim 38, wherein the act of reducing the supply current utilizes the detection current to interrupt the supply current.

40. The method according to claim 38, wherein the act of reducing the supply current further comprises the acts of:
transmitting the detection current to a circuit breaker arranged in the supply line; and
operating the circuit breaker to interrupt the supply current in the supply line.

41. The method according to claim 38, wherein the act of reducing the supply current further comprises the acts of:
detecting the detection current via a voltage produced by the detection current;
opening a switch located in the supply line via a signal derived from the detected voltage.

42. An apparatus for protecting a supply line in an event of an electrical arc in a 42V vehicle electrical system, the apparatus comprising:
at least one detection line at least part of which is arranged along the supply line, the supply line being connectable to a current source;
a protection device operable between the current source and the supply line, the protection device being driven by a detection current; and
wherein the detection line is surrounded by an insulation material having a defined melting temperature at which the insulation material becomes thinly viscous and flows away; and
whereby the electrical arc causes the defined melting temperature to be reached such that the protection line becomes electrically coupled with the supply line such that the detection current flows through the detection line causing the protection device to operate.

43. The apparatus according to claim 42, wherein the defined melting temperatures is between 130° C. and 180° C.
